(19) United States
(12) Patent Application Publication
(10) Pub. No.: US 2026/0072813 A1
(43) Pub. Date: Mar. 12, 2026

(54) PROMPT-DRIVEN CODE GENERATION AND DEVELOPMENT

(71) Applicant: Prompt Driven, Inc., Palo Alto, CA (US)

(72) Inventor: Greg L. Tanaka, Palo Alto, CA (US)

(21) Appl. No.: 19/322,429

(22) Filed: Sep. 8, 2025

Related U.S. Application Data
(60) Provisional application No. 63/692,141, filed on Sep. 8, 2024.
(60) Provisional application No. 63/848,330, filed on Jul. 22, 2025.

(51) Int. Cl. G06F 11/3668; G06F 8/35; G06F 8/71

(52) U.S. Cl. CPC G06F 11/3684; G06F 8/35; G06F 8/71

(57) ABSTRACT

The disclosed embodiments provide a technique for performing prompt-driven code generation and development. The technique includes determining a first version of a first prompt that is associated with a set of requirements for a system. The technique also includes generating, via execution of one or more machine learning models based on the first version of the first prompt, (i) a first code module associated with the system, (ii) a usage example associated with the first code module, and (iii) one or more tests of the code module. The technique further includes determining a second version of the first prompt based on (i) the first version of the first prompt and (ii) one or more results of the one or more tests and generating, via execution of the machine learning model(s) based on the second version of the first prompt, a second code module associated with the system.

### RELATED APPLICATION

This application claims the benefit of U.S. Provisional Application No. 63/692,141, entitled “System and Method for Prompt-Driven Software and Hardware Development,” filed Sep. 8, 2024, which is incorporated herein by reference in its entirety.

This application claims the benefit of U.S. Provisional Application No. 63/848,330, entitled “Prompt-Driven Development System,” filed Jul. 22, 2025, which is incorporated herein by reference in its entirety.

### BACKGROUND

### Field

The disclosure relates to software and hardware development. More specifically, the disclosure relates to prompt-driven code generation and development.

### Related Art

Traditional approaches to developing software and/or hardware have relied on manually written code as the primary artifact. For example, a software developer may use a programming language to write, modify, and/or maintain code for a software program. In another example, a hardware product may be defined by circuit behavior and structure that is specified using a hardware description language. However, these approaches can be time-consuming and error-prone and involve specialized knowledge of certain programming and/or hardware description languages.

Additionally, the overhead associated with maintaining and/or updating software and/or hardware systems increases with the size, complexity, and/or functionality of these systems. In particular, modifications to existing code are typically applied in the form of patches that target specific bugs, errors, and/or features. These patches can result in complex, interwoven code structures that become increasingly difficult to understand and/or modify. As patches are applied to large codebases, the accumulation of complexity in these codebases may cause the codebases to become increasingly difficult to understand and modify.

More recently, advances in machine learning and artificial intelligence (AI) have led to interactive coding tools that help streamline the process of writing and/or modifying code. For example, code completion tools may provide real-time suggestions and auto-complete functionality as developers type. In another example, interactive chat-based programming assistants driven by large language models (LLMs) may allow developers to describe desired functionality in natural language and receive corresponding code implementations and/or assistance with debugging or refactoring code. However, these AI-based tools continue to focus on localized changes or patches to existing codebases, thereby contributing to challenges in modifying and maintaining code over time.

Consequently, development of software, hardware, and/or systems that can be represented using code may be improved via techniques for reducing overhead and/or complexity associated with maintaining and/or updating these systems.

### BRIEF DESCRIPTION OF THE DRAWINGS

FIG. 1 illustrates a computer system in accordance with one or more embodiments.

FIG. 2 illustrates a system for performing prompt-driven code generation and development in accordance with one or more embodiments.

FIG. 3 illustrates different versions of an example prompt for generating a corresponding code module in accordance with one or more embodiments.

FIG. 4A illustrates an example code module that is generated based on a corresponding prompt in accordance with one or more embodiments.

FIG. 4B illustrates a set of usage examples associated with the code module of FIG. 4A in accordance with one or more embodiments.

FIG. 4C illustrates a set of tests associated with the code module of FIG. 4A in accordance with one or more embodiments.

FIG. 5 illustrates a flowchart of method steps for performing prompt-driven code generation and development in accordance with one or more embodiments.

In the figures, like reference numerals refer to the same figure elements.

### DETAILED DESCRIPTION

In the following detailed description, numerous specific details are set forth to provide a thorough understanding of the disclosed embodiments. However, it will be apparent to those skilled in the art that the disclosed embodiments may be practiced without these specific details. In other instances, well-known features have not been described in detail to avoid unnecessarily complicating the description.

Methods, structures, apparatuses, modules, and/or other components described herein may be enabled and operated using hardware circuitry, including but not limited to transistors, logic gates, and/or electrical circuits such as application-specific integrated circuits (ASICs), field-programmable gate arrays (FPGAs), digital signal processors (DSPs), and/or other dedicated or shared processors now known or later developed. Such components may also be provided using firmware, software, and/or a combination of hardware, firmware, and/or software.

The operations, methods, and processes disclosed herein may be embodied as code and/or data, which may be stored on a non-transitory computer-readable storage medium for use by a computer system. The computer-readable storage medium may correspond to volatile memory, non-volatile memory, hard disk drives (HDDs), solid-state drives (SSDs), hybrid disk drives (HDDs), magnetic tape, compact discs (CDs), digital video discs (DVDs), and/or other media capable of storing code and/or data now known or later developed. When the computer reads and executes the code and/or data stored on the computer-readable storage medium, the computer system performs the methods and processes embodied in the code and/or data.

### Overview

As discussed above, modifications to existing code are typically applied in the form of patches that target specific bugs, errors, and/or features, which can result in complex, interwoven code structures that become increasingly difficult to understand and/or modify. Additionally, continued application of patches may accumulate complexity in large codebases and cause the codebases to become increasingly difficult to understand and modify. Further, while AI-based interactive coding tools have streamlined the process of writing and/or modifying code, these tools continue to focus on localized changes or patches to existing codebases, thereby contributing to challenges in modifying and maintaining code over time.

To address the above limitations, the disclosed embodiments perform prompt-driven code generation and development, in which a prompt is used as a primary development artifact or “source of truth” for a system under development (e.g., hardware product, software program, engineered system, etc.) that can be defined and/or implemented using code modules. A set of requirements for the system under development is used to generate and/or is associated with a set of prompts for a large language model (LLM), vision language model (VLM), multimodal language model (MMLM), and/or another type of generative model that is capable of general-purpose understanding and generation of language and/or code. Each prompt may define behavior and/or constraints associated with one or more requirements for the system under development. Each prompt may be generated by a given generative model based on the set of requirements, provided by a user associated with design or implementation of the system under development, and/or obtained from another source and/or via another technique.

Each prompt is associated with one or more versions, and a given version of the prompt is used by one or more generative models to produce a code module, usage example, a set of one or more tests, and/or other artifacts. The code module is verified using the tests, formal verification techniques, and/or other techniques. Bugs, errors, crashes, conflicts, and/or other issues that are identified during verification of the module are used to update the code module, and the generative model(s) are used to generate a new version of the prompt based on the existing version of the prompt, the original code module generated using the existing version of the prompt, and the updated code module. The process can then be repeated using the new version of the prompt to generate a corresponding code module, usage example, and set of tests, thereby ensuring that a given set of artifacts is generated for each version of the prompt. Further, each code module may be verified using the corresponding set of tests and additional tests associated with previous versions of the prompt to improve test coverage of code for the system under development over time.

Because the disclosed embodiments use natural language prompts as a primary development artifact, changes to the system under development may be made in the form of discrete code modules that implement certain functionality and/or meet various requirements associated with the system under development. Consequently, the disclosed embodiments may avoid the accumulation of complexity and/or overhead associated with continued application of patches to existing codebases while ensuring that the generated code modules satisfy requirements and/or constraints. Further, the use of prompts, usage examples, and tests to define, generate, demonstrate, and/or verify the functionality of the code modules may improve the understanding, evaluation, and use of the code modules over conventional approaches, in which a series of patches that is applied to a codebase causes the codebase to gradually drift from documentation and/or specifications for the corresponding system under development.

### System Overview

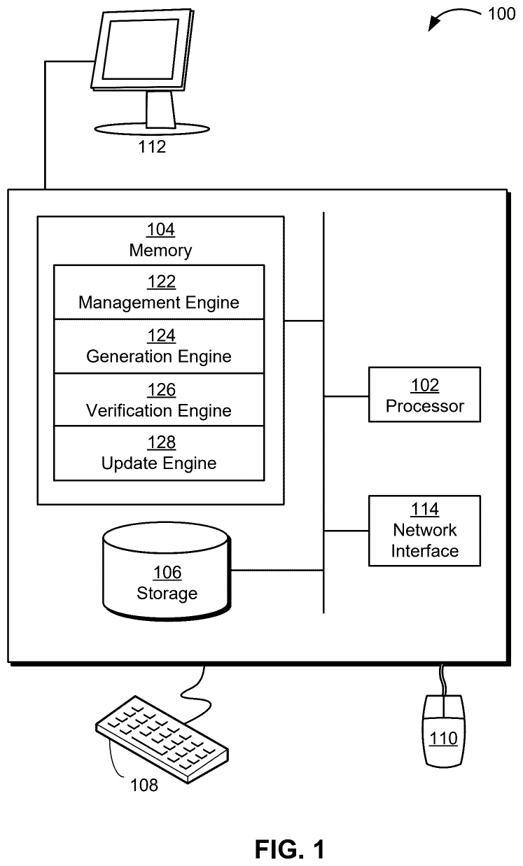

FIG. 1 shows a computer system 100 within which the disclosed embodiments can be implemented. Computer system 100 includes a processor 102, a memory 104, a storage 106, a network interface 114, and/or other components found in electronic computing devices. For example, computer system 100 may include (but is not limited to) a desktop computer, a laptop computer, a mobile phone, a personal digital assistant (PDA), a tablet computer, a game console, a smart home device, a server, a workstation, a virtual machine, and/or another arrangement of hardware and/or software components that can be configured to implement one or more disclosed embodiments.

Processor 102 may support parallel processing and/or multi-threaded operation within computer system 100. For example, processor 102 includes (but is not limited to), a central processing unit (CPU), graphics-processing unit (GPU), field programmable gate array (FPGA), application-specific integrated circuit (ASIC), artificial intelligence (AI) accelerator, another type of processing unit, and/or a combination of different processing units (e.g., a CPU operating in conjunction with a GPU).

Memory 104 includes cache memory, dynamic random-access memory (“DRAM”), video random-access memory (“VRAM”), non-volatile memory (e.g., flash memory), and/or other components that can store data. As shown in FIG. 1, memory 104 includes a management engine 122, a generation engine 124, a verification engine 126, and an update engine 128.

Storage 106 includes non-volatile storage for applications and data. For example, storage 106 may include one or more fixed and/or removable hard disk drives, solid state drives, flash memory devices, CD-ROMs (compact disc read-only-memories), DVD-ROMs (digital versatile disc-ROMs), and/or other magnetic, optical, or solid-state storage devices. Management engine 122, generation engine 124, verification engine 126, and update engine 128 can be stored in storage 106 and loaded into memory 104 when executed. The operation of management engine 122, generation engine 124, verification engine 126, and update engine 128 is described in further detail below.

Computer system 100 also includes input/output (I/O) devices such as (but not limited to) a keyboard 108, a mouse 110, and a display 112. Each I/O device can be capable of receiving input from a user and/or generating output to the user.

Network interface 114 includes hardware and/or software components that connect computer system 100 to a public and/or private network. For example, network interface 114 may include a network interface card (NIC), a virtual network interface (VNI), and/or another representation of an interface between computer system 100 and a network (not shown). The network may include (but is not limited to) a local area network (LAN), wide area network (WAN), personal area network (PAN), virtual private network, intranet, cellular network, Wi-Fi network (Wi-Fi® is a registered trademark of Wi-Fi Alliance), Bluetooth (Bluetooth® is a registered trademark of Bluetooth SIG, Inc.) network, universal serial bus (USB) network, Ethernet network, and/or switch fabric.

Computer system 100 includes functionality to execute various components of the present embodiments. In particular, computer system 100 includes an operating system (not shown) that coordinates the use of hardware and software resources on computer system 100, as well as one or more applications that perform specialized tasks for the user. To perform tasks for the user, applications obtain the use of hardware resources on computer system 100 from the operating system and interact with the user through a hardware and/or software framework provided by the operating system.

In addition, one or more components of computer system 100 may be remotely located and connected to the other components over a network. Portions of the present embodiments (e.g., management engine 122, generation engine 124, verification engine 126, update engine 128, etc.) may also be located on different nodes of a distributed system that implements the embodiments. For example, the present embodiments may be implemented using a distributed and/or cloud computing system that coordinates and/or manages the execution of remote tasks performed by management engine 122, generation engine 124, verification engine 126, and/or update engine 128. In another example, one or more instances of management engine 122, generation engine 124, verification engine 126, and/or update engine 128 may execute on various sets of hardware, types of devices, and/or environments to management engine 122, generation engine 124, verification engine 126, and/or update engine 128 to different use cases or applications. In a third example, management engine 122, generation engine 124, verification engine 126, and/or update engine 128 may execute on different computer systems and/or different sets of computer systems.

### Prompt-Driven Code Generation and Development

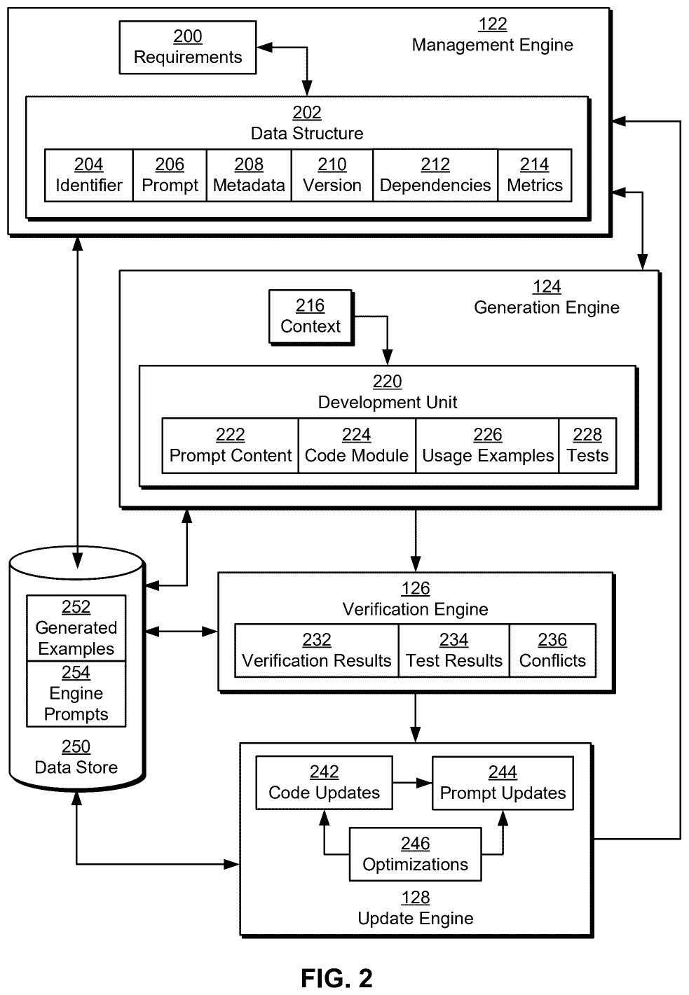

FIG. 2 illustrates a system for performing prompt-driven code generation and development in accordance with one or more embodiments. As shown in FIG. 2, the system includes management engine 122, generation engine 124, verification engine 126, update engine 128, and a data store 250. Each of these components is described in further detail below.

As mentioned above, prompt-driven code generation and development involves the use of prompts as primary development artifacts or sources of truth for code modules that define and/or implement a system under development. More specifically, a set of requirements 200 for the system under development is used to generate and/or is associated with a set of prompts for a large language model (LLM), vision language model (VLM), multimodal language model (MMLM), and/or another type of generative model that is capable of general-purpose understanding and generation of language and/or code.

In one or more embodiments, each prompt 206 defines and/or represents the behavior and/or constraints associated with one or more requirements 200 for the system under development. Prompt content 222 for each prompt 206 may be generated by a generative model based on one or more requirements 200, provided by a user involved in designing and/or implementing the system under development, and/or obtained from another source and/or via another technique.

Management engine 122 uses a data structure 202 to store and/or manage information associated with a given prompt 206. As shown in FIG. 2, data structure 202 includes an identifier 204 for each prompt 206, metadata 208 associated with that prompt 206, a version 210 of that prompt 206, one or more dependencies 212 associated with that prompt, and/or one or more metrics 214 associated with that prompt.

Identifier 204 may be used to distinguish a given prompt 206 from other prompts. For example, identifier 204 may include a universally unique identifier (UUID), alphanumeric string (e.g., a string that includes and/or is generated based on one or more corresponding requirements 220), and/or another value that can be used to locate and/or reference prompt 206.

Metadata 208 may include information that can be used to organize, contextualize, manage, and/or search for a corresponding prompt 206. For example, metadata 208 may include creation timestamps, modification dates, author information, tags or keywords (e.g., “security”, “user-interface”, “database”), priority levels, complexity ratings, and/or textual descriptions of a given prompt 206. Metadata 208 may also, or instead, include information about a target programming language or platform associated with prompt 206, requirements 200 that are relevant to the corresponding prompt 206, constraints associated with that prompt 206, and/or other information that relates prompt 206 to attributes of the system under development. Metadata 208 may also, or instead, identify additional documentation and/or external resources that provide additional information that is relevant to the corresponding prompt 206.

Version 210 may represent a specific iteration or revision of prompt 206. For example, each version 210 may be associated with specific text, changes in text, improvements, and/or bug fixes that distinguish that version 210 from previous versions of the same prompt 206.

A given version 210 may be represented using semantic versioning (e.g., “1.0.0”, “1.2.3”, “2.0.0-beta”, etc.), sequential numbering (e.g., “v1”, “v2”, “v3”, etc.), timestamp-based versioning (e.g., “2024-01-15-14:30:22”), and/or branching information (e.g., “main-v1.2”, “feature-branch-v0.8”, etc.). A given version 210 may also, or instead, link to or reference a user and/or entity that requested or triggered the corresponding change to prompt 206, a rationale for changing the prompt, and/or artifacts affected by the change. Version 210 may also, or instead, denote and/or be associated with a type of change (e.g., over a previous version 210 of the same prompt 206). This type of change may include (but is not limited to) a major change that alters the purpose of prompt 206, a minor change that includes refinements or additions but maintains the same core intent as one or more previous versions of prompt 206, and/or a patch that includes small corrections or clarifications over one or more previous versions of prompt 206.

Dependencies 212 may identify relationships between different prompts associated with the system under development. For example, dependencies 212 may specify hierarchical (e.g., one prompt 206 depends on or uses functionality associated with another prompt 206), lateral (e.g., two or more prompts represents interrelated components within the system under development), and/or other types of relationships between the prompts. Dependencies 212 may also, or instead, specify version-specific relationships, such as requiring a minimum version 210 of another prompt 206 and/or compatibility with a range of versions of a given prompt 206. Dependencies 212 may also, or instead, include external dependencies on libraries, frameworks, and/or components that are not generated using prompts.

Metrics 214 may include quantitative measurements and performance indicators associated with a given version 210 of prompt 206 and the corresponding generated artifacts. For example, metrics 214 may include (but are not limited to) generation success rates, execution times, resource usage, application programming interface (API) costs associated with using generative models and/or other tools to generate that version 210 of prompt 206 and/or the corresponding artifacts, test coverage percentages, and/or bug detection rates. Metrics 214 may also, or instead, include quality metrics such as (but not limited to) prompt and/or code complexity scores, maintainability indices, and/or user ratings. Metrics 214 may also, or instead, track usage statistics, such as (but not limited to) how frequently a prompt is regenerated, the number of successful deployments associated with a given prompt 206 or version 210 of that prompt 206, and/or the average time between version 210 changes in a given prompt 206.

After a given instance of data structure 202 is generated and/or populated with identifier 204, prompt 206, metadata 208, version 210, dependencies 212, and/or metrics 214, management engine 122 may store and/or update that instance in a relational database, graph database, vector database, data warehouse, key-value store, distributed filesystem, cloud storage, and/or another type of data store 250. Generation engine 124, verification engine 126, update engine 128, and/or other components may subsequently access data store 250 to retrieve and/or update a given instance of data structure 202 during processing associated with the corresponding prompt 206.

In one or more embodiments, management engine 122 associates each prompt 206 (and corresponding data structure 202) with a corresponding set of one or more requirements 200 for the system under development. For example, management engine 122 may organize requirements 200 into logical groupings based on functionality, complexity, dependencies, and/or other characteristics and create one or more prompts 206 for each grouping. Management engine 122 may also, or instead, create one-to-one mappings between requirements 200 and prompts, so that each prompt 206 addresses a single, specific requirement. Management engine 122 may also, or instead, associate multiple related requirements 200 with a single prompt 206 when these requirements 200 share common functionality, target the same component, and/or exhibit strong interdependencies. Management engine 122 may also, or instead, define a given prompt 206 and/or data structure 202 based on user input that specifies one or more requirements 200 associated with that prompt 206 and/or rules or guidelines for mapping requirements 200 to prompts.

In some embodiments, management engine 122 decomposes high-level requirements 200 and/or a single prompt 206 into multiple prompts that address specific aspects or implementation details of the broader requirement. For example, management engine 122 may represent a requirement for user authentication using separate prompts for login functionality, password validation, session management, and/or security logging. Conversely, management engine 122 may consolidate fine-grained requirements 200 into higher-level prompts that encompass broader capabilities.

Management engine 122 may also, or instead, create cross-cutting prompts that address requirements 200 spanning multiple components or layers. These prompts may handle concerns such as error handling, logging, security, and/or performance optimization that affect multiple parts of the system under development. Management engine 122 may also, or instead, generate interface prompts that address requirements 200 related to communication between different components of the system under development and/or between the components and external systems.

After management engine 122 has mapped a set of requirements 200 to one or more corresponding prompts, generation engine 124 generates a development unit 220 for each prompt 206. Each development unit 220 includes prompt content 222 for a certain version 210 of that prompt 206. For example, each development unit 220 may include prompt content 222 in the form of natural language text, images, audio, video, and/or other data that describes the functionality, behavior, constraints, and/or other attributes associated with one or more corresponding requirements 200.

Each development unit 220 also includes a code module 224 that implements and/or meets the functionality, behavior, and/or constraints specified in the corresponding prompt content 222. For example, each code module 224 may include one or more functions, methods, interfaces, classes, objects, and/or other discrete “units” of code that are generated based on prompt content 222.

Each development unit 220 further includes one or more usage examples 226 that demonstrate how to use and/or interact with the corresponding code module 224. For example, usage examples 226 may include sample code, configuration files, command-line invocations, and/or other executable units that can be used to call functions, instantiate classes, configure parameters, and/or otherwise use code module 224. Usage examples 226 may also, or instead, include input/output examples that illustrate expected behavior under various conditions, edge cases, and/or error scenarios.

Each development unit 220 additionally includes one or more tests 228 that verify the correctness, functionality, and/or performance of the corresponding code module 224. For example, tests 228 may include (but are not limited to) unit tests 228 that validate individual functions, methods, or “units” of code within the code module 224; integration tests 228 that verify interactions between the code module 224 and other code modules 224 or components; and/or end-to-end tests 228 that validate complete workflows involving the code module 224. Tests 228 may also, or instead, include performance tests 228 that measure execution time, memory usage, and/or other metrics 214 associated with the code module 224. Tests 228 may also, or instead, include regression tests 228 that verify that code module 224 does not break existing functionality, boundary tests 228 that validate behavior at input limits, and/or error handling tests 228 that verify appropriate responses to invalid inputs or exceptional conditions.

In one or more embodiments, generation engine 124 uses an LLM, VLM, MMLM, and/or another type of generative model to generate and/or update some or all portions of development unit 220. More specifically, generation engine 124 may generate and/or update a given portion of development unit 220 (e.g., prompt content 222, code module 224, usage examples 226, tests 228, etc.) using information from data structure 202, other portions of development unit 220, and/or one or more engine prompts 254 from data store 250. Each engine prompt may act as a system-level prompt that provides higher-level directives for the generation of a corresponding portion of development unit 220.

An example engine prompt that is used to update prompt content 222 for a given version 210 of prompt 206 with dependencies 212 may include the following:

You are an expert prompt engineer. Your goal is to properly insert in dependencies into a prompt.

Here are few examples of how to properly insert dependencies into a prompt:

```
<examples>
  <example id=“1”>
    INPUT:
      <prompt_to_update><include>
        context/insert/1/prompt_to_update.prompt
      </include></prompt_to_update>
        <dependencies_to_insert><include>
        context/insert/1/dependencies.prompt
      </include></dependencies_to_insert>
    OUTPUT:
      <updated_prompt><include>
        context/insert/1/updated_prompt.prompt
      </include></updated_prompt>
  <example>
  <example id=“2”>
    INPUT:
      <prompt_to_update><include>
        context/insert/2/prompt_to_update.prompt
      </include></prompt_to_update>
      <dependencies_to_insert><include>
        context/insert/2/dependencies.prompt
      </include></dependencies_to_insert>
    OUTPUT:
      <updated_prompt><include>
        context/insert/2/updated_prompt.prompt
      </include></updated_prompt>
  <example>
<examples>
```

Generate the output for following inputs based on above examples:

<prompt_to_update>{actual_prompt_to_update}</prompt_to_update>
<dependencies_to_insert>
{actual_dependencies_to_insert}
</dependencies_to_insert>

The output prompt will be in JSON format with the following keys:
‘explanation’: A string containing of why the dependencies were inserted in a certain location in the prompt.
‘output_prompt’: A string containing the prompt with the dependencies inserted.

An example engine prompt that is used to generate one or more usage examples 226 for a given code module 224 may include the following:

You are an expert software engineer. Generate a concise example of how to use the following module properly:
<code_module>{code_module}</code_module>

Here is the prompt used to generate the module:
<prompt_for_code>{processed_prompt}</prompt_for_code>

The language of the example should be in:
<language_for_example>{language}</language_for_example>

Make sure the following happens:
Document in detail the input and output parameters in the doc strings
Someone needs to be able to fully understand how to use the module from the example.
<include>./context/example.prompt</include>

An example engine prompt that is used to generate one or more tests 228 of a given code module 224 may include the following:

You are an expert {language} Software Test Engineer. Your task is to generate a {language} unit test to detect issue(s) in code_under_test. The test should compare the current output with the desired output and to ensure the code behaves as expected. If Python, use Pytest.

### Inputs:

Current output: <current_output>{current_output}</current_output>
Desired output: <desired_output>{desired_output}</desired_output>
Code under test:
<code_under_test>{code_under_test}</code_under_test>
Program used to run the code under test:

<program_used_to_run_code_under_test>
{program_used_to_run_code_under_test}
</program_used_to_run_code_under_test>

Prompt that generated the code:

<prompt_that_generated_code>
{prompt_that_generated_code}
</prompt_that_generated_code>

Output: A unit test that detects the problem(s) and ensures the code meets the expected behavior.

Follow these steps to generate the unit test:
1. Analyze the current output: Compare the current and desired outputs to identify discrepancies and explain the issue in several paragraphs.
2. Based on the above analysis explain in several paragraphs how the issues can be reproduced without having false positives.
3. Write a test that properly detects the issue in the code_under_test so that if the test passes, the issue is fixed.

Focus exclusively on writing a robust unit test to detect and identify the issue(s) in the code provided. The test should not focus on the internals of the code but rather the inputs and outputs so that the test can be reused if the code is regenerated.

An example engine prompt that is used to generate additional tests 228 of a given code module 224 (given one or more existing tests 228) may include the following:

You are an expert Software Test Engineer. Given an existing set of unit tests along with their coverage reports, generate additional unit tests that provide more coverage for the code under test.

Here is a description of what the code is supposed to do and was the prompt that generated the code: “‘{prompt_that_generated_code}’”

Here is the code under test: “‘{code}’”

Here are the existing unit tests: “‘{existing_unit_tests}’”

Here is the coverage report: “‘{coverage_report}’”

Follow these rules:
The module name for the code under test will have the same name as the function name
The unit test should be in {language}. If Python, use pytest.
Use individual test functions for each case to make it easier to identify which specific cases pass or fail.
Use the description of the functionality in the prompt to generate tests with useful tests with good code coverage.
<include>./context/test.prompt</include>

In one or more embodiments, generation engine 124 further generates a given portion of development unit 220 (e.g., prompt content 222, code module 224, usage examples 226, tests 228, etc.) based on a context 216 that includes one or more generated examples 252 from data store 250. Each of generated examples 252 includes a previously generated development unit 220 for the same system under development and/or a different system under development.

In some embodiments, generated examples 252 are selected and incorporated into context 216 based on similarity measures computed between generated examples 252 and corresponding portions of development unit 220. For example, generation engine 124 may identify generated examples 252 that are semantically similar to prompt content 222 by computing similarity measures (e.g., cosine similarities, Euclidean distances, Jaccard similarities, etc.) between one or more embeddings of prompt content 222 and one or more corresponding embeddings of each generated example. A certain number of generated examples 252 with the highest similarity measures and/or a variable number of generated examples 252 with similarity measures that meet or exceed a specified threshold may be selected for inclusion in context 216.

Generation engine 124 may also, or instead, use keyword-based matching, syntactic analysis, and/or domain-specific similarity measures to identify generated examples 252 that are relevant to prompt content 222 and/or other portions of a corresponding development unit 220. For example, generation engine 124 may include, in context 216, generated examples 252 that use similar programming languages, frameworks, libraries, and/or design patterns as those specified in and/or associated with prompt content 222. Generated examples 252 that address similar functional requirements, implement comparable algorithms, and/or handle analogous edge cases may also be selected for inclusion in context 216 for the generation of code module 224, usage examples 226, and/or tests 228 associated with prompt content 222.

In some embodiments, generation engine 124 tailors the inclusion of generated examples 252 in context 216 to the type of data being generated. For example, context 216 for the generation of code module 224 may include pairs of prompts and code modules that are similar and/or relevant to prompt content 222 used to generate code module 224. Context 216 for the generation of usage examples 226 may include groupings of prompts, code modules, and/or usage examples that are similar and/or relevant to prompt content 222 and/or code module 224 used to generate usage examples 226. Context 216 for the generation of tests 228 may include groupings of prompts, code modules, and/or tests that are similar and/or relevant to prompt content 222 and/or code module 224 used to generate tests 228.

In one or more embodiments, generation engine 124 filters and/or ranks generated examples 252 based on quality metrics and/or user feedback associated with previously generated artifacts. For example, generated examples 252 that have been associated with successful code generation, high test coverage, comprehensive coverage of requirements 200 and/or attributes associated with the corresponding prompts, deployment into production environments, incorporation into a product, and/or positive user ratings may be prioritized for inclusion in context 216 over generated examples 252 associated with compilation errors, test failures, negative user ratings, lack of deployment or use, and/or other issues.

In some embodiments, context 216 includes additional information that is relevant to the generation of a corresponding artifact. For example, context 216 may include documentation, design records, external sources of data, guidelines, service level agreements (SLAs), interface specifications, and/or other information that is determined by generation engine 124, a user, embedding-based similarity measures, keyword matches, metadata, and/or another entity or mechanism to be relevant to the artifact. Generation engine 124 may use context-packing techniques (e.g., embedding-based ranking, chunking, deduplication, window packing, etc.) to condense this information into essential features or points. Generation engine 124 may also, or instead, attach provenance metadata (e.g., source, version, hash, etc.) to this information within context 216.

After a given development unit 220 is generated, generation engine 124 stores that development unit 220 in data store 250 for subsequent retrieval and use. For example, generation engine 124 may store prompt content 222, code module 224, usage examples 226, and/or tests 228 with a unique identifier for development unit 220. Generation engine 124 may also, or instead, store a mapping between development unit 220 and data structure 202 for the corresponding prompt 206 and/or prompt version 210.

While development unit 220 has been described has including prompt content 222, code module 224, usage examples 226, and/or tests 228, it will be appreciated that development unit 222 may include additional artifacts and/or omit one or more artifacts. For example, development unit 220 may include context 216, documentation, user comments, and/or metadata related to prompt content 222, code module 224, usage examples 226, and/or tests 228. In another example, development unit 220 may include a model name, model version, temperature parameter, top-p parameters, random seed, and/or other information related to the generation of a given artifact by a corresponding generative model. This information can be used to “replay” or reproduce the process of generating the artifact under the same parameters and/or conditions. This information may also, or instead, be used to adjust and/or optimize one or more parameters and/or conditions under which the artifact is generated to generate one or more variations of the artifact (e.g., when the originally generated artifact is associated with suboptimal performance, functionality, adherence to prompt content 222, and/or other undesirable attributes). In a third example, development unit 220 may omit usage examples 226 and/or tests 228 (e.g., if usage examples 226 and/or tests 228 in previous development units 220 for the same prompt 206 are deemed to have sufficient coverage and/or demonstrability of prompt content 222 and/or code module 224).

Verification engine 126 performs analyses to verify the functionality and/or operation of code module 224. In one or more embodiments, verification engine 126 uses formal verification and/or other techniques to generate verification results 232 that verify that code module 224 satisfies requirements 220 associated with a corresponding prompt 206 and/or constraints specified in prompt content 222 for a given version 210 of that prompt 206.

For example, verification engine 126 may use model checking to explore possible states and transitions of code module 224 and verify that code module 224 satisfies specified requirements 200 related to safety, liveness, and/or other attributes. Verification engine 126 may also, or instead, use theorem proving techniques to mathematically demonstrate the correctness of code module 224 by constructing formal proofs that the implementation in code module 224 meets a corresponding specification. Verification engine 126 may also, or instead, use static analysis techniques to identify potential issues such as (but not limited to) null pointer dereferences, buffer overflows, type mismatches, and/or unreachable code in code module 224. Verification engine 126 may also, or instead, perform abstract interpretation to analyze the behavior of code module 224 over abstract domains for the purposes of detecting runtime errors and/or verifying code module 224 properties. Verification engine 126 may also, or instead, use a Satisfiability Modulo Theories (SMT) solver to verify the correctness of code module 224 using symbolic logic and formulas that are automatically generated from prompt content 222. Verification engine 126 may also, or instead, generate verification results 232 by applying contract-based verification techniques that check whether code module 224 satisfies pre-conditions, post-conditions, and/or invariants specified in the corresponding prompt content 222 and/or requirements 220. Verification engine 126 may also, or instead, use refinement checking to verify that code module 224 correctly implements a higher-level specification (e.g., by demonstrating that every behavior of the implementation corresponds to a behavior allowed by the specification).

Verification engine 126 also generates test results 234 by executing tests 228 against code module 224. For example, verification engine 126 may execute unit, integration, performance, and/or other types of tests 228 generated by generation engine 124 and/or obtained from another source to validate the behavior, functionality, and/or performance characteristics of code module 224. Test results 234 of these tests 228 may include (but are not limited to) a pass/fail status for each test, coverage metrics indicating which portions of code module 224 and/or prompt content 222 were exercised during one or more tests 228, execution times for performance-related tests 228, and/or detailed error messages or stack traces for failed tests 228.

In some embodiments, test results 234 include mutation testing results 234 that are generated by introducing small changes to code module 224 and evaluating the effectiveness of tests 228 in detecting and responding to these changes. Verification engine 126 may also, or instead, perform property-based testing that generates random inputs satisfying specified properties and verifies that code module 224 behaves correctly across a wide range of input conditions.

Verification engine 126 additionally includes functionality to detect conflicts 236 associated with a given code module 224 and/or corresponding prompt content 222. These conflicts 236 may include contradictory requirements associated with different versions of the same prompt 206 and/or different prompts, changes introduced in a new code module 224 and/or prompt content 222 for a given prompt 206 that affect other code modules and/or prompts that depend on the new code module 224 and/or prompt 206, changes to the same prompt 206 by two or more users, changes to requirements 200 that affect one or more prompts, and/or other incompatibilities associated with requirements 200, prompts, prompt versions, code modules, and/or other types of artifacts.

Verification engine 126 stores verification results 232, test results 234, and/or conflicts 236 associated with development unit 220 in data store. Verification engine 126 may also, or instead, associate the stored verification results 232, test results 234, and/or conflicts 236 with corresponding portions of development unit 220 and/or data structure 202. For example, verification engine 126 may include, in data store 250, mappings between portions of development unit 220 and/or data structure 202 and/or the corresponding verification results 232, test results 234, and/or conflicts 236. Verification engine 126 may also, or instead, store verification results 232, test results 234, and/or conflicts 236 as additional data and/or metadata that is included in the corresponding portions of development unit 220 and/or data structure 202.

Update engine 128 uses verification results 232, test results 234, and/or conflicts 236 from verification engine 126 and/or data store 250 to apply code updates 242 to a given code module 224 and/or prompt updates 244 to prompt content 222 used to generate that code module 224. In some embodiments, update engine 128 performs code updates 242 that address bugs, errors, crashes, incompatibilities, and/or other issues identified in verification results 232, test results 234, and/or conflicts 236. Update engine 128 also uses these code updates 242 to generate corresponding prompt updates 244 to prompt content 222.

Update engine 128 may additionally apply optimizations 246 to code updates 242 and/or prompt updates 244 to improve the performance and/or overhead associated with code module 224 and/or prompt content 222. In some embodiments, optimizations 246 include performance enhancements that reduce execution time, memory usage, and/or computational complexity of code module 224. For example, optimizations 246 may involve replacing inefficient sorting algorithms with more efficient alternatives, optimizing data structures to reduce memory footprint, implementing caching mechanisms to avoid redundant computations, and/or other operations that are aimed at reducing overhead and/or latency associated with executing code module 224. Optimizations 246 may also, or instead, improve code readability and maintainability by refactoring complex functions into smaller modular components, eliminating code duplication, and/or standardizing naming conventions and coding styles.

In one or more embodiments, optimizations 246 include improvements that reduce API costs, network bandwidth usage, storage requirements, and/or other types of resource utilization associated with code module 224. For example, update engine 128 may optimize database queries to reduce the number of round trips, implement data compression techniques to minimize storage overhead, and/or batch multiple operations to reduce API call frequency.

Update engine 128 may also, or instead, apply optimizations 246 to prompt updates 244 in a way that improves the clarity, specificity, and effectiveness of prompt content 222. These optimizations 246 may include (but are not limited to) refining natural language descriptions to reduce ambiguity, adding specific examples or constraints to guide generation of various artifacts, and/or incorporating lessons learned from previous iterations to prevent recurring issues. Optimizations 246 may also, or instead, involve restructuring prompt content 222 to better align with the capabilities and/or limitations of the generative models used by generation engine 124.

In one or more embodiments, optimizations 246 are determined based on analysis of metrics 214 collected over multiple iterations of the prompt-driven development process. For example, update engine 128 may identify patterns in code generation failures, test execution times, and/or resource consumption to determine which types of optimizations 246 are most beneficial for specific types of prompts and/or code modules. Update engine 128 may also, or instead, use machine learning techniques, rules, and/or heuristics to predict which optimizations 246 are likely to be most effective based on characteristics of prompt content 222, code module 224, and/or historical performance data.

As with the generation of development unit 220, an LLM, VLM, MMLM, and/or another type of generative model may be used to determine at least a portion of verification results 232, test results 234, conflicts 236, code updates 242, prompt updates 244, and/or optimizations 246. More specifically, verification engine 126 and/or update engine 128 may generate one or more portions of verification results 232, test results 234, conflicts 236, code updates 242, prompt updates 244, and/or optimizations 246 using information from data structure 202, development unit 220, and/or one or more engine prompts 254 from data store 250. Each engine prompt may act as a system-level prompt that provides higher-level directives for the generation of a specific type of output.

An example engine prompt that is used to generate verification results 232 associated with code module 224 and prompt content 222 may include the following:

You are an expert Software Engineer. Your goal is to identify any discrepancies between a program, its code_module, and a prompt. You also need to check for any potential bugs or issues in the code.

Here is the program that is running the code_module:
<program>{program}</program>

Here is the prompt that generated the program and code_module:
<prompt>{prompt}</prompt>

Here is the code_module that is being used by the program:
<code_module>{code}</code_module>

Here are the output logs from the program run:
<output_logs>{output}</output_logs>

### Important Considerations:

1. The prompt may describe only part of the functionality needed by the program.
2. Always consider compatibility between the program and code_module as the highest priority.
3. Functions used by the program must exist in the code_module, even if not mentioned in the prompt.
4. The prompt might only request new functionality to be added to existing code.

Follow these steps to identify any issues:
Step 1. First, identify all functions and features in the code_module that are used by the program, as these must be preserved.
Step 2. Compare the program and code_module against the prompt and explain any discrepancies.
Step 3. Analyze the input/output behavior of the program and verify if it meets the expected behavior described in the prompt.
Step 4. Identify any potential edge cases, error handling issues, or performance concerns that could cause problems in the future.
Step 5. Check the code for potential bugs that haven't manifested yet.
Step 6. If any issues are found, explain in detail the root cause of each issue and how it could impact the program's functioning.
Step 7. Carefully distinguish between:
   a. Incompatibilities (functions called by program but missing from code_module)—these are critical issues
   b. Prompt adherence issues (code doesn't match prompt requirements)—these are important but secondary to compatibility
   c. Implementation issues (bugs, edge cases)—these should be addressed without breaking compatibility

After your analysis, determine the number of distinct issues found. If no issues are found, the count should be 0.

Return your response as a single, valid JSON object. The JSON object must conform to the following structure:

```
<example_output>
  {{
    “details”: “A detailed explanation of all steps taken during your
    analysis, including any discrepancies, bugs, or potential issues
    identified. If no issues are found, this can be a brief confirmation.”,
    “issues_count”: <integer_count_of_issues_found>
  }}
</example_output>
```

Ensure the “details” field contains your complete textual analysis from Steps 1-7 and ensure the “issues_count” is an integer representing the total number of distinct problems you've identified in your details.

An example engine prompt that is used to generate one or more code updates 242 to code module 224 based on errors found in test results 234 for one or more tests 228 may include the following:

You are an expert Software Engineer. Your goal is to diagnose and fix the errors from a unit_test run on the code_under_test. The error might be in the code_under_test or the unit_test or both.

Here is the unit_test for the code_under_test:
<unit_test>{unit_test}</unit_test>

Here is the code_under_test: <code_under_test>{code}</code_under_test>

Here is the prompt that generated the code_under_test:
<prompt>{prompt}</prompt>

This prompt is run iteratively. Here are the current errors and past potential fix attempts, if any, from the unit test and verification program run(s):
<errors>{errors}</errors>

If the verification program fails to run, the code_under_test and unit_test are unchanged from the previous iteration.

```
<pdd>
<examples>
  <example_1>
    Here is an example_unit_test for the example_code_under_test:
    <example_unit_test><include>context/fix_errors_from_unit_tests/1/t
    est_conflicts_in_prompts.py</include></example_unit_test>
    Here is an example_code_under_test that fully passes the
    example_unit_test:
    <example_code_under_test><include>context/fix_errors_from_unit_te
    sts/1/conflicts_in_prompts.py</include></example_code_under_test
    >
    Here is the prompt that generated the example_code_under_test:
    <example_prompt><include>context/fix_errors_from_unit_tests/1/co
    nflicts_in_prompts_python.prompt</include></example_prompt>
  </example_1>
  <example_2>
    Here is an example_unit_test for the example_code_under_test:
    <example_unit_test><include>context/fix_errors_from_unit_tests/4/t
    est_detect_change_1_0_1.py</include></example_unit_test>
    Here is an example_code_under_test that didn't fully pass the
    example_unit_test:
    <example_code_under_test><include>context/fix_errors_from_unit_te
    sts/4/detect_change_1_0_1.py</include></example_code_under_test
    >
      Here is an example error/fix log showing how the issues were
    resolved:
    <example_error_fix_log><include>context/fix_errors_from_unit_tests
    /4/error.log</include></example_error_fix_log>
  </example_2>
</examples>
</pdd>
<instructions>
Follow these steps to solve these errors:
    Step 1. Compare the prompt to the code_under_test and explain
    differences, if any.
    Step 2. Compare the prompt to the unit_test and explain differences, if
    any.
    Step 3. For each prior attempted fix for the code_under_test and unit_test
    (if any), explain in a few paragraphs for each attempt why it might not
    have worked.
    Step 4. Write several paragraphs explaining the root cause of each of the
    errors and each of the warnings in the code_under_test and unit_test.
    Step 5. Explain in detail step by step how to solve each of the errors and
    warnings. For each error and warning, there should be several
    paragraphs description of the solution steps. Sometimes logging or print
    statements can help debug the code in subsequent iterations. It is
    important to make sure the tests are still sufficiently comprehensive to
    catch potential errors.
    Step 6. Review the above steps and correct for any errors and warnings in
    the code under test or unit test.
    Step 7. For the code that need changes, write the corrected
    code_under_test and/or corrected unit_test in its/their entirety.
</instructions>
```

An example engine prompt that is used to generate one or more code updates 242 to fix crashes associated with code module 224 may include the following:

You are an expert Software Engineer. Your goal is to fix the errors in a code_module AND/OR program that is causing that program to crash.

IMPORTANT: The crash command should fix whatever needs to be fixed to make the program run successfully:
If the code module has bugs, fix the code module
If the calling program has bugs, fix the calling program
If both have issues that contribute to the crash, fix BOTH
The goal is to ensure the program runs without errors after all fixes are applied

Here is the program that is running the code_module that crashed and/or has errors: <program>{program}</program>

Here is the prompt that generated the code_module below:
<prompt>{prompt}</prompt>

Here is the code_module that is being used by the program:
<code_module>{code}</code_module>

Here are the error log(s) from the program run and potentially from prior program run fixes: <errors>{errors}</errors>

NOTE: The errors field contains a structured history of previous fixing attempts with XML tags and human-readable content:

```
<attempt number=“X”> - Start of each attempt record
  <verification>
  Status: Success/failure status with return code
  Output: [Standard output text]
  Error: [Error message text]
  </verification>
  <current_error>
  [Current error message to be fixed]
  </current_error>
  <fixing>
  <llm_analysis>
    [Analysis from previous attempts in human-readable format]
  </llm_analysis>
  <decision>
    update_program: true/false
    update_code: true/false
  </decision>
  </fixing>
</attempt>
```

When analyzing errors, you should:
1. Review the history of previous attempts to understand what has been tried
2. Pay attention to which fixes worked partially or not at all
3. Avoid repeating approaches that failed in previous attempts
4. Focus on solving the current error found within the <current_error> tags

Follow these steps to solve these errors:
Step 1. Compare the prompt to the code_module and explain differences, if any.
Step 2. Compare the prompt to the program and explain differences, if any.
Step 3. Explain in detail step by step why there might be an error and why prior attempted fixes, if any, may not have worked. Write several paragraphs explaining the root cause of each of the errors.
Step 4. Explain in detail step by step how to solve each of the errors. For each error, there should be several paragraphs description of the steps. Consider whether the fix requires:
   Updating the code_module only
   Updating the calling program only
   Updating BOTH the code_module AND the calling program

Sometimes logging or print statements can help debug the code_module or program.
Step 5. Review the above steps and correct for any errors in the logic.
Step 6. For ALL code that needs changes, write the corrected code_module and/or corrected program in their entirety. If both need fixes, provide both complete fixed versions.

An example engine prompt that is used to generate one or more prompt updates 244 based on code updates 242 to code module 244 may include the following:

```
<role>
    You are an expert LLM Prompt Engineer. Your goal is to change the
    input_prompt into a modified_prompt according to the change_prompt.
</role>
<inputs_outputs_definitions>
  Here are the inputs and outputs of this prompt:
  <input>
    ‘input_prompt’ - A string that contains the prompt that will be
    modified by the change_prompt.
    ‘input_code’ - A string that contains the code that was generated from
    the input_prompt.
    ‘change_prompt’ - A string that contains the instructions of how to
    modify the input_prompt.
  </input>
  <output>
    ‘modified_prompt’ - A string that contains the modified prompt that
    was changed based on the change_prompt.
  </output>
</inputs_outputs_definitions>
<change_prompt_examples>
  <include>
    ../prompts/xml/change_example_partial_processed.prompt
  </include>
</change_prompt_examples>
<context>
  Here is the input_prompt to change:
<input_prompt>{input_prompt}</input_prompt>
  Here is the input_code generated from the input_prompt:
<input_code>{input_code}</input_code>
  Here is the change_prompt to implement:
<change_prompt>{change_prompt}</change_prompt>
</context>
<instructions>
  Follow these instructions:
  Step 1. Explain in detail step by step the ramifications of the
  change_prompt on the input_prompt.
  Step 2. Explain in detail step by step what changes need to be made to the
  input_prompt to generate the modified_prompt based on Step 1. This step
  describes how to modify the input_prompt to generate the
  modified_prompt.
  Step 3. Generate the modified_prompt based on Step 2. Except for the
  change, the rest of the existing functionality of the input_prompt should
  remain. Structure the prompt similar to the example prompts, especially
  including the descriptions of the inputs and outputs.
</instructions>
<important_notes>
    Never ask if you should proceed with generating the modified_prompt as
    this prompt has no human monitoring. Always assume that the
    change_prompt is correct and proceed with generating the
    modified_prompt. Also, for step 3, output the modified prompt not just
    how to modify the prompt.
</important_notes>
```

An example engine prompt that is used to detect conflicts 236 associated with prompt content 222 for different versions of the same prompt 206 and/or different prompts may include the following:

You are a software architect and prompt engineering expert tasked with analyzing two prompts for potential conflicts and suggesting resolutions. Your goal is to identify any inconsistencies or contradictions between the prompts and provide constructive and detailed suggestions on how to resolve these conflicts.

```
<inputs>
  Here are the two prompts you need to analyze:
  <prompt_1>{PROMPT1}</prompt_1>
  <prompt_2>{PROMPT2}</prompt_2>
</inputs>
```

Follow these instructions:
1. Carefully read and analyze both prompts. Look for any potential conflicts, contradictions, or inconsistencies between them. Consider aspects such as:
   Goals or objectives
   Specific instructions or requirements
   Assumptions or context
2. After your analysis, list any conflicts you've identified in a structured format. Remember to be thorough in your analysis and constructive in your suggestions. Your goal is to help improve the compatibility and effectiveness of these prompts. For each conflict, provide the following:
   Detailed explanation of why this is a conflict
   Suggestion on how to resolve this conflict
   Determine which prompt(s) would be best to changed and how
3. Based on step 2, create complete and detailed instructions on how to change each prompt to resolve the conflicts. Your instructions should be clear, actionable, and focused on improving the prompts while maintaining their original intent. Everything that is needed to know how to change the prompt effectively should be included here.

An example engine prompt that is used to detect conflicts 236 between a change to requirements 200 and a set of prompts may include the following:

You are an expert prompt engineer. You will be given a list of LLM prompts and a change description. Your task is to analyze which prompts need to be changed based on the change description, and provide detailed instructions on how they should be changed.

Here are the inputs:

```
<input>
  <prompt_list>
  {PROMPT_LIST}
  </prompt_list>
  <change_description>
  {CHANGE_DESCRIPTION}
  </change_description>
</input>
```

Here is an example of an output for a given input:

```
<example>
  <input_example>
    <prompt_list_example>
    <include>context/detect_change/2/prompt_list.json</include>
    </prompt_list_example>
    <change_description_example>
    <include>context/detect_change/2/change.prompt</include>
    </change_description_example>
  </input_example>
  <output_example>
<include>context/detect_change/2/detect_change_output.txt</include>
  </output_example>
</example>
```

Follow these steps to complete the task:

```
<task>
Step 1. Carefully read and analyze the change description. Consider
its implications and how it might affect different types of prompts.
Step 2. Review each prompt in the prompt list. For each prompt,
determine if it needs to be changed based on the change
description. Some prompts maybe unaffected by the change
description or already have the changes applied.
Step 3. In your analysis, consider the following:
  - How does the change description impact each prompt?
  - Are there any potential issues or conflicts that might arise from
  implementing the change?
  - What are different ways the change could be implemented for
  affected prompts?
  - Where is the best place to implement the change to minimize
  issues and maximize effectiveness?
Step 4. Prepare your response in the following format:
  <analysis>
    1. Provide a detailed description of the impact of the change and
    potential issues.
    2. Generate at least three different possible implementation plans.
    Discuss the pros and cons of each plan.
    3. Analyze the potential issues and the different plans. Explain
    step by step which plan is the best and why.
    4. For each prompt explain if it needs to be changed based on the
    selected plan.
    5. List the prompts that need to be changed based on the
    selected plan.
    For each prompt that needs to be changed, include:
    a. The prompt's name
    b. Detail and complete instructions for a LLM of how the prompt
    should be changed. Everything that is needed to know how to
    change the prompt effectively should be included here.
    - When instructing to include content from another file vs.
    actually intending to include file contents:
      1. Mention the filename that should be included.
      2. Describe where in the prompt the file's contents should be
      inserted.
      3. Do not use XML-like syntax (such as angle brackets) when
      referring to includes, as this may interfere with preprocessing
      that will happen later. For example: “Insert the contents of the
      file ‘./context/python_preamble.prompt’ immediately after the
      role and goal statement using ‘include’ XML tags. The format
      for this is ‘include’ in angle brackets, followed by the file path
      then closed with ‘include’ in angle brackets.”
    - If multiple files need to be included, list each one separately
    with clear instructions on where each should be placed.
    - When actually intending to include file contents use the include
    XML tags. This is common when the include will be replacing
    existing content.
    - Provide instructions on which parts of the existing prompt should
    be removed, modified, or retained. Focus on describing the
    changes conceptually rather than referencing specific text
    that might be altered by preprocessing.
    - Ensure that any unique instructions or logic specific to the
    prompt being modified are retained and remain clear.
    - Remember to include any other relevant instructions for
    modifying the prompt that are not related to file inclusions.
    - When finished, review the instructions to ensure they will make
    sense after any preprocessing steps that may occur.
    </analysis>
</task>
```

Remember to be thorough in your analysis and clear in your explanations. Consider all aspects of the change description and its potential impacts on the prompts.

Update engine 128 may store code updates 242, prompt updates 242, and/or optimizations 246 in data store 250. Update engine 128 may also, or instead, generate one or more mappings within data store 250 that associate the stored code updates 242, prompt updates 242, and/or optimizations with the corresponding prompt content 222, code module 224, development unit 220, and/or data structure 202.

In one or more embodiments, generation engine 124, verification engine 126, and/or update engine 128 run in a closed loop that iteratively tests and updates code module 224 until a given set of bugs, errors, crashes, and/or other issues is resolved. For example, a bug report, set of test results 234, and/or other data indicating one or more issues may be provided by a user, verification engine 126, an external testing system, and/or another entity. Generation engine 124 may generate additional tests 228 that reproduce and/or are otherwise related to the issue(s). Verification engine 126 may run these tests 228 to generate corresponding test results 234, and update engine 128 may generate code updates 242 and/or optimizations 246 based on the generated test results 234. Verification engine 126 may rerun the same tests 228 on the updated code module 224, and update engine 128 may generate additional code updates 242 and/or optimizations 246 based on the corresponding test results 234 until test results 234 indicate that the issue(s) have been resolved.

After prompt updates 244 are used to update prompt content 222 for a given version 210 of prompt 206, management engine 122 stores the updated prompt content 222 as a new version 210 of prompt 206 in data structure 202. Generation engine 124 may also use the new version 210 of prompt 206 to generate a new development unit 220 that includes a corresponding code module 224, set of usage examples 226, and/or set of tests 228.

In one or more embodiments, management engine 122 and/or generation engine 124 include functionality to split lengthy and/or complex prompt content 222 for a given version 210 of prompt 206 into multiple smaller prompts that are used to generate corresponding development units. An example engine prompt that is used to perform this splitting may include the following:

You are an expert LLM Prompt Engineer. Your goal is to split the input_prompt (a larger prompt) into a sub_prompt and modified_prompt (two smaller prompts) with no loss of functionality. This is to make it easier to generate and test the modules easier.

Here are the inputs and outputs of this prompt:

```
  <input_definitions>
  Input:
    ‘input_prompt’ - A string contains the prompt that will be split into
    a sub_prompt and modified_prompt.
    ‘input_code’ - A string that contains the code that was generated
    from the input_prompt.
    ‘example_code’ - A string that contains an interface defining the
    specific functionality to extract into the sub_prompt. The
    sub_prompt will generate code that implements this interface.
  </input_definitions>
  <output_definitions>
  Output:
    ‘sub_prompt’ - A string that contains the extracted functionality as
    defined by the example_code interface that was split from the
    input_prompt.
    ‘modified_prompt’ - A string that contains the modified original
    prompt that will import and use the functionality defined in the
    sub_prompt.
  </output_definitions>
</context>
<inputs>
  <input_prompt>{input_prompt}</input_prompt>
  <input_code>{input_code}</input_code>
  <example_code>{example_code}</example_code>
</inputs>
<instructions>
  Follow these instructions:
  1. Write several paragraphs to explain based on the example_code how
  the input_prompt could be split into a sub_prompt and
  modified_prompt.
  2. Write out several paragraphs in detail all the functionality of the
  sub_prompt by looking at the input_prompt and input_code.
  3. Write out what are the possible difficulties in splitting the prompt
  according to the input example_code. For each difficulty write several
  paragraphs
  4. Write out how to overcome the difficulties. Write several paragraphs
  for each difficulty.
  5. Write the sub_prompt which would generate the code that could be
  used by the example_code. This prompt should carefully consider all
  the prior steps and ensure enough detail is provided to generate the
  code properly. Internal modules need to be imported using include
  and other appropriate xml tags in the same style as the input_prompt.
  6. Write the complete modified_prompt which would incorporate the
  sub_prompt without any duplications or conflicting functionalities.
</instructions>
```

For each new version 210 of a given prompt 206 (e.g., after the first version 210 has been generated), generation engine 124 may include, as context 216 for generating a corresponding artifact (e.g., code module 224, usage examples 226, tests 228, etc.), generated examples 252 that include prompt content 222, code modules, usage examples 226, and/or tests 228 for one or more previous versions of that prompt 206. These generated examples 252 may be provided in lieu of or in addition to generated examples 252 for other prompts.

Verification engine 126 may also generate a new set of verification results 232, test results 234, and/or conflicts 236 associated with each new development unit 220. In one or more embodiments, verification engine 126 generates test results 234 using tests 228 from the new development unit 220 and previously generated tests 228 from development units associated with older versions of the same prompt 206. Consequently, tests 228 of prompt 206 may increase in coverage and/or comprehensiveness over time.

Update engine 128 similarly uses the latest verification results 232, test results 234, and/or conflicts 236 to generate and apply code updates 244, prompt updates 244, and/or optimizations 246 to the new development unit 220. Each new set of prompt updates 244 may also be used to generate a new version 210 of the corresponding prompt 206 and trigger the generation of a corresponding development unit 220. Thus, the system of FIG. 2 may regenerate, update, and/or verify a given portion of the system under development based on different versions of a corresponding prompt 206 that act as sources of truth for the behavior and/or functionality of that portion.

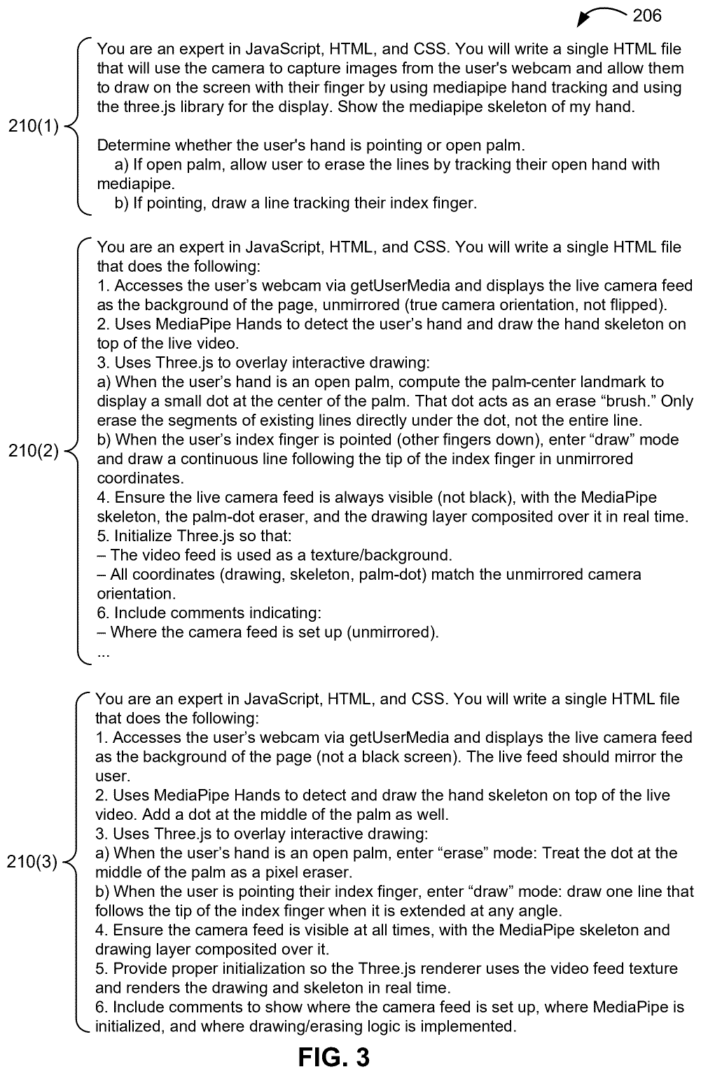

FIG. 3 illustrates different versions 210(1)-210(3) of an example prompt 206 for generating a corresponding code module 224 in accordance with one or more embodiments. Version 210(1) may correspond to an initial version of prompt 206 that is provided by a user and/or generated by a generative model based on one or more requirements 200 for a system under development. This version 210(1) includes a relatively short description of the functionality to be achieved in generating code module 224.

Version 210(2) may correspond to an intermediate version of prompt 206 (e.g., after one or more rounds of iterative updates have been made to version 210(1)). As shown in FIG. 3, version 210(2) includes specific directives related to steps to be performed, tools to be used, behavior to be implemented, and/or comments to be generated in code module 224.

Version 210(3) may correspond to a final version of prompt (e.g., after the corresponding code module 224 has been verified to operate correctly, passed all tests 228, resolve outstanding conflicts 236, incorporate relevant optimizations 246, etc.). This final version 210(3) includes a condensed version of the directives in version 210(2) and may be generated after one or more rounds of iterative updates have been made to version 210(2).

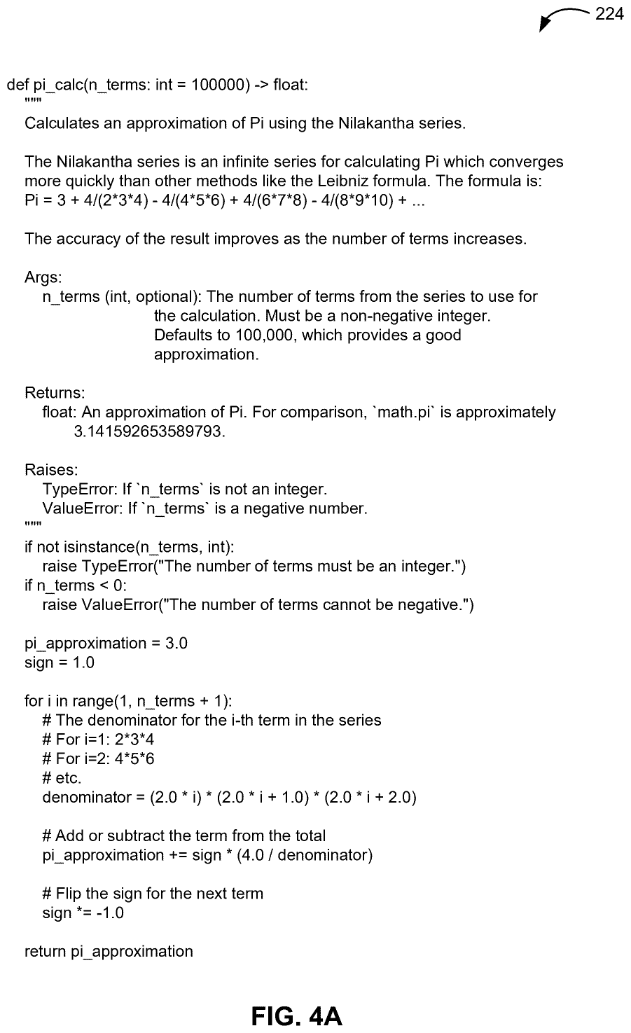

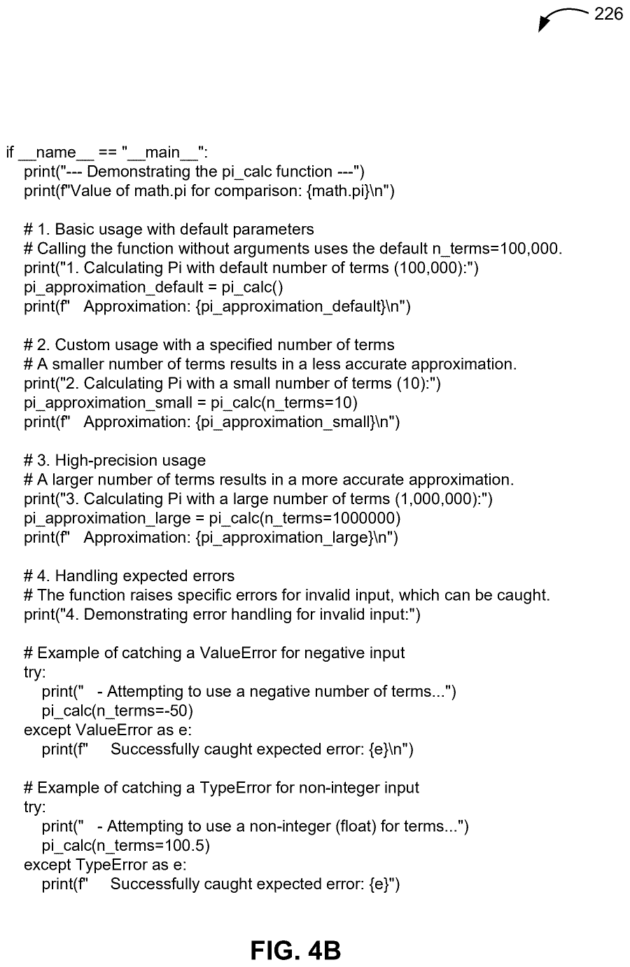

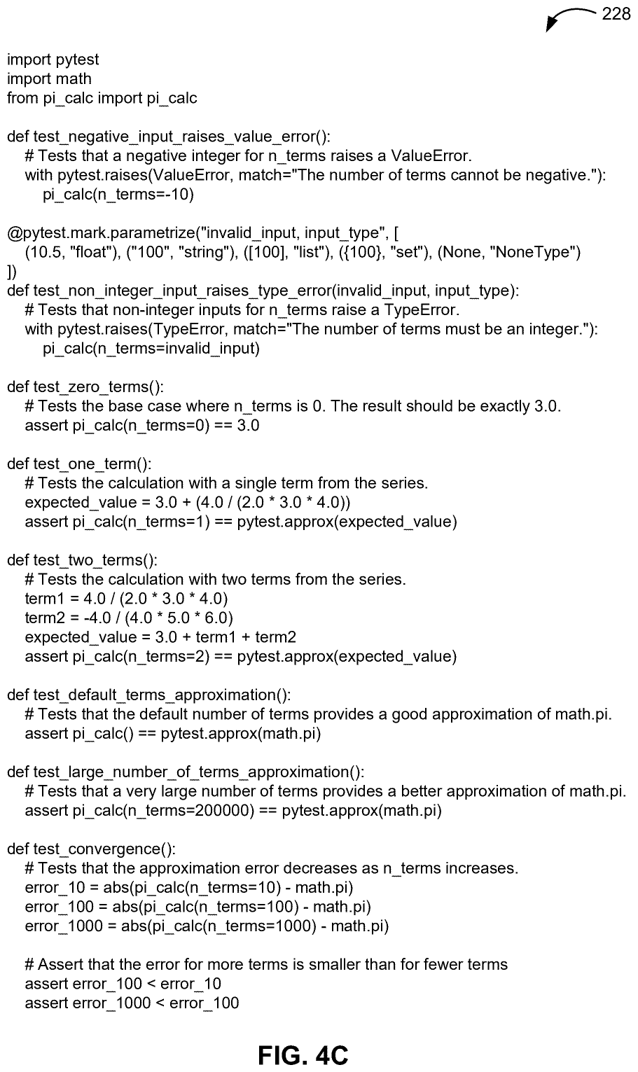

FIG. 4A illustrates an example code module 224 that is generated based on a corresponding prompt 206 in accordance with one or more embodiments. As shown in FIG. 4A, the example code module 224 includes code that is used to calculate an approximation of pi using the Nilakantha series. The example code module 224 may be generated using prompt content 222 of “write a Python function ‘pi_calc’ that calculates Pi.”

FIG. 4B illustrates a set of usage examples 226 associated with code module 224 of FIG. 4A in accordance with one or more embodiments. As shown in FIG. 4B, usage examples 226 can be used to demonstrate basic usage, custom usage, high-precision usage, and/or error handling associated with code module 224.

FIG. 4C illustrates a set of tests 228 associated with code module 224 of FIG. 4A in accordance with one or more embodiments. As shown in FIG. 4C, tests 228 can be used to verify that errors are raised when negative integers and/or non-integers are provided as the number of terms in the Nilakantha series. These tests 228 can also be used to test the behavior of code module 224 with different numbers of terms and/or verify a reduction in the approximation error as the number of terms increases.

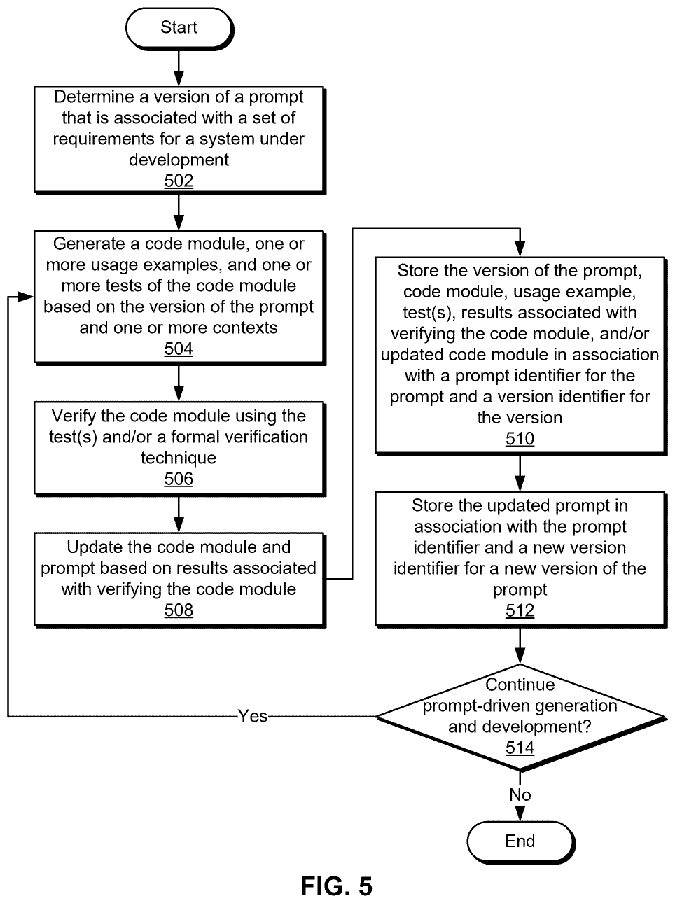

FIG. 5 illustrates a flowchart of method steps for performing prompt-driven code generation and development in accordance with one or more embodiments. In one or more embodiments, one or more of the steps may be omitted, repeated, and/or performed in a different order. Accordingly, the specific arrangement of steps shown in FIG. 5 should not be construed as limiting the scope of the embodiments.

Initially, a version of a prompt that is associated with a set of requirements for a system under development is determined (step 502). For example, the prompt may be provided by a user, generated by a machine learning model (e.g., an LLM, VLM, MMLM, and/or another type of generative model) based on the requirements, and/or otherwise determined or mapped to the set of requirements.

Next, a code module, one or more usage examples, and one or more tests of the code module are generated via execution of one or more machine learning models based on the version of the prompt (step 504). For example, an LLM, VLM, MMLM, and/or another type of generative model may be used to produce the code module, usage example(s), and/or test(s). The generative model may operate based on input that includes (i) the version of the prompt; (ii) one or more engine prompts that specify roles, tasks, instructions, rules, and/or other directives for the generation of the code module, usage example, and/or test(s); and/or (iii) a context that includes generated examples of similar prompts, code modules, usage examples, and/or tests.

The code module is verified using the test(s) and/or a formal verification technique (step 506). For example, each test may be executed against the code module to generate test results that identify bugs, errors, exceptions, crashes, and/or other runtime issues. Formal verification techniques may also, or instead, be used to verify the correctness and/or other attributes of the code module. Verification of the code module may also, or instead, involve identifying conflicts associated with the code module, the corresponding version of the prompt, and/or dependencies associated with the prompt or code module.

The code module and prompt are updated based on results associated with verifying the code module (step 508). For example, code updates may be applied to the code module to address bugs, errors, incompatibilities, conflicts, inconsistencies, logical correctness issues, and/or other issues identified in step 506. The code updates may be used to generate and apply corresponding updates to prompt content for the version of the prompt, resulting in new prompt content that reflects changes in behavior, functionality, and/or constraints associated with the updated code module. Optimizations may also be performed during the updates to the code module and/or prompt to improve performance and/or reduce overhead.

The version of the prompt, code module, usage example, test(s), results associated with verifying the code module, and/or updated code module are then stored in association with a prompt identifier for the prompt and a version identifier for the version (step 510). For example, management engine 122 may store prompt content for the version of the prompt, code module, usage example, and/or test(s) in a development unit within a data store. Management engine 122 may also associate the development unit with a data structure that includes the prompt identifier, version identifier, metadata for the prompt, dependencies associated with the prompt, and/or metrics associated with the prompt.

The updated prompt is also stored in association with the prompt identifier and a new version identifier for a new version of the prompt (step 512). Continuing with the above example, prompt content for the updated prompt may be mapped to the prompt identifier and new version identifier within the data structure.

A determination is then made as to whether or not to continue prompt-driven generation and development (step 514). For example, prompt-driven generation and development may continue while bugs, errors, and/or other issues are identified in results associated with verifying the code module and/or semantic, logical, and/or functional differences are found between the existing and new versions of the prompt. Prompt-driven generation and development may also, or instead, continue until the prompt and code module have been updated over a certain number of iterations, based on a user request, and/or based on another trigger or condition.

If prompt-driven generation and development is to continue, steps 504, 506, 508, 510, and 512 are repeated to generate, verify, update, and/or store artifacts corresponding to the new version of the prompt. Step 514 may also be repeated to selectively continue the process of iteratively updating the system under development based on different versions of the prompt. Thus, the system under development may continue to be updated based on different versions of the prompt until a given version of the prompt produces a code module that passes all tests generated across all versions of the prompt, is verified to behave correctly with respect to the corresponding requirements, meets one or more requirements and/or thresholds associated with performance or resource consumption, does not conflict with other code modules and/or components used by the system under development, and/or meets other criteria.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

Although the disclosed embodiments have been described with respect to a limited number of embodiments, those skilled in the art, having benefit of this disclosure, will appreciate that many modifications and changes may be made without departing from the spirit and scope of the disclosed embodiments. Accordingly, the above disclosure is to be regarded in an illustrative rather than a restrictive sense. The scope of the embodiments is defined by the appended claims.

What is claimed is:

1. A method, comprising:
determining a first version of a first prompt that is associated with a set of requirements for a system;
generating, via execution of one or more machine learning models based on the first version of the first prompt, (i) a first code module associated with the system, (ii) a usage example associated with the first code module, and (iii) one or more tests of the code module;
determining a second version of the first prompt based on (i) the first version of the first prompt and (ii) one or more results of the one or more tests; and
generating, via execution of the one or more machine learning models based on the second version of the first prompt, a second code module associated with the system.

2. The method of claim 1, further comprising:
storing the first version of the first prompt in association with a prompt identifier for the first prompt and a first version identifier for the first version; and
storing the second version of the first prompt in association with the prompt identifier and a second version identifier for the second version.

3. The method of claim 1, further comprising:
generating one or more additional tests of the second code module; and
verifying the second code module using the one or more tests and the one or more additional tests.

4. The method of claim 1, further comprising:
determining that a second prompt associated with the set of requirements includes a dependency on the first prompt; and
updating the second prompt based on the second version of the first prompt.

5. The method of claim 4, further comprising:
generating a third code module associated with the system based on the updated second prompt.

6. The method of claim 1, wherein determining the first version of the first prompt comprises at least one of:
generating, via execution of the one or more machine learning models, the first prompt based on the set of requirements and one or more prompt-generation examples; or
receiving at least a portion of the first prompt from a user.

7. The method of claim 1, wherein generating the first code module, the usage example, and the one or more tests comprises:
matching at least one of the first code module, the usage example, and the one or more tests to one or more generated examples; and
inputting the first prompt and a context that includes the one or more generated examples into the one or more machine learning models.

8. The method of claim 1, wherein determining the second version of the first prompt comprises:
applying, based on the one or more results of the one or more tests, one or more updates to the first code module to generate an updated first code module; and
generating the second version of the first prompt based on the updated first code module.

9. The method of claim 1, wherein the first code module, the usage example, the one or more tests, and the second code module are further generated by the one or more machine learning models based on at least one of:
a role;
a task;
one or more instructions; or
one or more rules.

10. The method of claim 1, wherein the second version of the first prompt is further generated based on one or more updates to the first code module.

11. One or more non-transitory computer-readable storage media storing instructions that, when executed by one or more processors, cause the one or more processors to perform a method, the method comprising:
determining a first version of a first prompt that is associated with a set of requirements for a system;
generating, via execution of one or more machine learning models based on the first version of the first prompt, (i) a first code module associated with the system, (ii) a usage example associated with the first code module, and (iii) one or more tests of the code module;
determining a second version of the first prompt based on (i) the first version of the first prompt and (ii) one or more results of the one or more tests; and
generating, via execution of the one or more machine learning models based on the second version of the first prompt, a second code module associated with the system.

12. The one or more non-transitory computer-readable storage media of claim 11, wherein the method further comprises:
storing the first version of the first prompt in association with a prompt identifier for the first prompt, a version identifier for the first version, and one or more dependencies between the first prompt and one or more additional prompts associated with the system.

13. The one or more non-transitory computer-readable storage media of claim 11, wherein determining the second version of the first prompt comprises:
applying, based on the one or more results of the one or more tests, one or more updates to the first code module to generate an updated first code module;
retrieving the first prompt based on the prompt identifier and the version identifier; and
generating, via execution of the one or more machine learning models based on the first code module, the updated first code module, and the first prompt, the second version of the first prompt.

14. The one or more non-transitory computer-readable storage media of claim 11, wherein the method further comprises:
storing the first version of the first prompt, the first code module, the usage example, the one or more tests, and the one or more results of the one or more tests in association with a prompt identifier for the first prompt and a version identifier for the first version.

15. The one or more non-transitory computer-readable storage media of claim 11, wherein the method further comprises:
determining that the first prompt includes a dependency on a second prompt associated with the set of requirements;
generating a third version of the first prompt based on an update to the second prompt; and
generating a third code module based on the third version of the first prompt.

16. The one or more non-transitory computer-readable storage media of claim 15, wherein the first prompt is associated with a first requirement in the set of requirements and the second prompt is associated with a second requirement in the set of requirements.

17. The one or more non-transitory computer-readable storage media of claim 11, wherein generating the first code module, the usage example, and the one or more tests comprises:
matching at least one of the first code module, the usage example, or the one or more tests to one or more generated examples; and
inputting the first prompt and a context that includes the one or more generated examples into the one or more machine learning models.

18. The one or more non-transitory computer-readable storage media of claim 16, wherein the one or more generated examples are matched to the first code module, the usage example, or the one or more tests based on one or more similarity measures computed using one or more embeddings of the one or more generated examples.

19. The one or more non-transitory computer-readable storage media of claim 11, wherein the system comprises at least one of a hardware system or a software system.

20. A system, comprising:
one or more processors; and
memory storing instructions that, when executed by the one or more processors, cause the system to perform operations comprising:
determining a first prompt that is associated with a set of requirements for a system;
generating, via execution of one or more machine learning models based on the first prompt, (i) a first code module associated with the system and (ii) one or more tests of the code module;
determining a second prompt based on (i) the first prompt and (ii) one or more results of the one or more tests; and
generating, via execution of the one or more machine learning models based on the second prompt, a second code module associated with the system.
